(19) United States
(12) Patent Application Publication
(10) Pub. No.: US 2021/0309194 A1
(43) Pub. Date: Oct. 7, 2021

(54) TRAILER MANAGEMENT SYSTEM

(71) Applicant: Curt Manufacturing, LLC, Eau Claire, WI (US)

(72) Inventors: Donald Thomas, Columbiana, OH (US); Christian Barcey, Canfield, OH (US); Joecyl Sanchez, Canfield, OH (US); Brian Lipczynski, Warren, OH (US); Adam Divelbiss, Austintown, OH (US)

(21) Appl. No.: 14/067,195

(22) Filed: Oct. 30, 2013

Related U.S. Application Data
(60) Provisional application No. 61/720,282, filed on Oct. 30, 2012.

(51) Int. Cl. B60T 8/24; B62D 13/00; B60T 8/17; B60T 7/20; B60D 1/24; B60D 1/26

(52) U.S. Cl. CPC B60T 8/248; B62D 13/00; B60T 8/1708; B60T 2230/02; B60D 1/248; B60D 1/26; B60T 2230/06; B60T 7/203

(57) ABSTRACT

A wireless vehicle trailer monitoring system comprising: a monitoring circuit operatively coupled to a trailer controller, the monitoring circuit configured to detect a fault condition with an associated trailer; a trailer wireless transceiver operatively coupled to the monitoring circuit; and a towing vehicle wireless transceiver operatively coupled to an associated towing vehicle, wherein the trailer wireless transceiver is configured to communication wirelessly with the towing vehicle wireless transceiver

### TECHNICAL FIELD OF THE INVENTION

The technology of the present disclosure relates generally to monitoring systems used with trailers and, more particularly, to a multi-function trailer management system.

### BACKGROUND

Each day over a million trailers, e.g., box trailers, boat trailers, caravans and the like, are towed on the nation's highways. With over a million trailers being towed on the nation's highways, millions of dollars in personal property are being towed across the nation. Personal property can range from personal luggage to private watercrafts. These items can be towed by vehicles ranging from diesel vehicles to small luxury SW's. Thus, the towing of personal belongings is a common way to transfer massive amounts of goods from one location to another.

Typically, trailers include lighting systems, e.g., tail lights, brake lights, turn signal lights, etc., as well as electric braking systems. From time to time, various fault conditions may occur with the trailer lighting and/or braking systems. For example, a lamp on the trailer may fail or the electric brakes may become disconnected or otherwise fail. Because trailer lamps are not visible to the driver of the towing vehicle, the driver may continue to drive without knowing that a trailer lamp has failed. Similarly, the trailer's brakes may become disconnected or otherwise fail without the driver being aware of the fault condition.

In addition to lighting systems and braking systems, trailers may also include tire pressure monitoring systems, on-board cameras, mileage trackers, hub temperature systems, and/or proximity sensors.

### SUMMARY

A multi-function trailer management system and method is proposed.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a diagrammatic illustration of towing vehicle and a trailer employing a wireless trailer monitoring and control system;

FIG. 2 is a diagrammatic illustration of an exemplary bits profile that may be employed in connection with the disclosed technology;

FIG. 3 is a diagrammatic illustration of an exemplary data stream that may be employed in connection with the disclosed technology;

FIG. 4 is an electrical schematic of an exemplary trailer brake monitor circuit for use in connection with the disclosed technology;

FIG. 5 is a diagrammatic illustration of an exemplary wireless trailer monitor and/or control system;

FIG. 6 is a diagrammatic illustration providing a detailed view of a portion of FIG. 5;

FIG. 7 is a diagrammatic illustration providing a detailed view of a portion of FIG. 5;

FIG. 8 is a diagrammatic illustration providing a detailed view of a portion of FIG. 5;

FIG. 9 is a diagrammatic illustration of an exemplary status module in accordance with one embodiment;

FIG. 10 is a diagrammatic illustration of an exemplary status module in accordance with another embodiment;

FIG. 11 is a schematic view of the connection of a brake control system to a towing vehicle and trailer;

FIG. 12 is a schematic view of an exemplary brake control system;

FIG. 13 is a system block diagram of an exemplary brake control system;

FIGS. 14a-14c are perspective views of an enclosure of the brake control system;

FIG. 15 is an exemplary wiring diagram of the proportional brake control device;

FIGS. 16a and 16b are flow diagrams representing exemplary calibration actions taken by various components of the brake control system;

FIG. 17 is a flow diagram representing exemplary actions taken by various components of the brake control system;

FIG. 18 is a diagram of the degrees of freedom of movement of an inertial measurement unit; and

FIG. 19 is a diagram of a computation by the Pythagorean Theorem.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

### Overview of Multi-Function Trailer Management System

Operationally, the multi-function trailer management system includes a user Interface for one or more of the following: Information Systems, Trailer Lighting Monitors, Tire Pressure Monitors, Brake Controls, On-Board Cameras, Trailer Mileage Tracker/Hub Temperature Sensor, Proximity Sensors, Sway Controls and ABS Brake Systems. Functionally, it can be viewed as a Status Monitor for some or all of the sensors attached to the trailer system.

Various modules can be attached through a Can Bus System. (CAN is a multi-master broadcast serial bus standard for connecting electronic control units (ECUs). Each ECU is able to send and receive messages, but not simultaneously. A message can include an ID (identifier), which represents the priority of the message, and up to eight data bytes. It can be transmitted serially onto the bus. This signal pattern is encoded in non-return-to-zero (NRZ) and is sensed by all ECU. If the bus is free, any node may begin to transmit. If two or more nodes begin sending messages at the same time, the message with the more dominant ID (which has more dominant bits, i.e., zeroes) will overwrite other nodes' less dominant IDS, so that eventually (after this arbitration on the ID.) only the dominant message remains and is received by all nodes)

The multi-function trailer management system can include a user interface in the form of a Touchscreen Display for user interface, which also can be used as an Information System, or it could be connected to various Smart Phone Applications. The System and Modules can be used individually or in an environment tailored to the individual's needs/requirements.

### Information System:

### User Guide and Helpful Tips

This System can be used as a user guide and trip resource. The guides and tips will be displayed through the touch screen. The user is able to scroll through the necessary information needed to properly hook-up, tow, and maintenance their trailer. This feature helps bridge the gap between the novice tower and the experienced tower.

### Trailer Lighting Monitor

This System Monitors the Trailer Lighting System and detects bulbs that have failed. Additional details are provided below.

### Tire Pressure Monitor:

This System Monitors, both the Trailer and Towing Vehicle Tire Air Pressures for individual tires. The pressures output is transmitted wirelessly to the Display. Audible and Visual alarms can be activated if the tire pressure drops below or rises above user presets.

### Brake Control

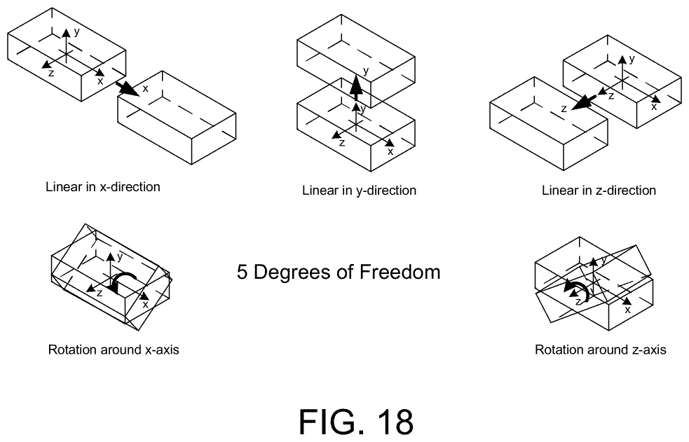

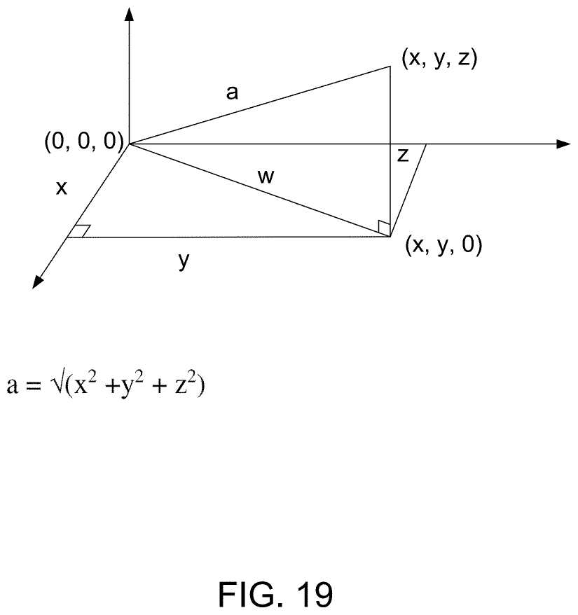

This System can include a “Proportional” Brake Control. The brake controller's Inertial Measurement Unit has 5 Degrees of Freedom, a combination of 3-axis accelerometer and 2-axis gyroscope (see FIG. 18). The accelerometer determines Acceleration/deceleration direction and magnitude and the MCU will translate this to equivalent braking power to the trailer. Although the accelerometer can determine tilt, it needs the input of the gyroscope to have a much better noise immunity against linear shaking and vibration. The gyroscope will also determine if the towing vehicle is banking left or right. Also with 5 Degrees of Freedom, there is a wide range of mounting position for the Brake Controller. In addition, the gyroscope will determine any change around the vertical axes such as going up and down hills.

Linear Accelerometers are susceptible to linear vibrations and thus the Gyro acts to filter these linear vibrations due to the fact that the Gyro only respond to changes in angular momentum.

In summary the 3-axes accelerometer is used to determine the motion azimuth and the static “level” condition of the towing vehicle during calibration. Subsequent to the auto-calibration of the brake controller, the accelerometer is used to determine gross acceleration along the vehicle azimuth and the 2-axis gyroscope is used to modify these readings due to vehicle banking, turns, and vertical plane changes (up and down hills).

The unit employs an averaging technique on raw data from the Accelerometer and Gyroscope to further reduce noise and false readings due to bumps and vehicle vibration.

### Calibration Mode of the Proportional Brake Controller

At the start of the calibration, when the vehicle is at level ground, the MCU request from the accelerometer what are the readings or data of X, Y and Z axes. The accelerometer responds with the data of X, Y and Z axes, and these values is determined to be the Gravity Vector. The MCU then sends this values back to the accelerometer as Offset Values which the accelerometer then adjust its reading of the X, Y and Z axes by subtracting it with these Offset Values. The result is that at level ground after calibration, the readings of the accelerometer are zero which in effect took out Gravity Vector from the accelerometer itself.

### Computing for Braking Power

When the user hits the brake pedal and the MCU detect this, the MCU will request data from both the accelerometer (X, Y and Z axes reading) and the Gyroscope, every data requested from the Accelerometer is being compared from the Gyro data to determine if it is a linear deceleration in parallel with the vehicle or a linear vibration which is not parallel with the vehicle. If the data match the linear the deceleration it used to create an average data of an axis. Magnitude is then computed by Pythagorean Theorem:

a=√(x²+y²+z²)
Where:
   a=deceleration g-force magnitude
   x, y and z=magnitude of the g-force along that axis
      After getting the deceleration magnitude it is then further refined by applying the factor of the sensitivity of the braking output which is determined by “Load Level Select”.

Duty=(a*100)/PWM_Mod

### Where:

Duty=Duty Cycle of the brake output in percent
a=deceleration g-force magnitude
PWM_Mod=constant factor determined by Load Level Select

The Duty cycle is then compared with the Gain setting which determines the maximum power output, if it is greater than the Gain setting, the Duty Cycle will be equal to the Gain Setting. The result is a Duty Cycle of the output of the Brake Controller which had a frequency of 300 Hz.

### On Board Cameras:

This System allows for onboard cameras to be mounted in the interior of the trailer (cargo, horse, car trailers) to constantly or periodically view precious cargo and exterior of trailer for backing and side monitoring.

### Trailer Mileage Tracker and Hub Temperature Sensors:

The System allows for towed mileage to be recorded and to monitor hub temperature to insure proper lubrication. This System insures proper maintenance and upkeep of trailer axles. This System will be designed with a hall-effect sensor mounted in a cap, attached to the front of the trailers hub. It may also use an optical wheel sensor, also on the hub.

Trailer Coupling Monitoring—This feature will alert the user of a loose coupling connection to the trailer. If the coupling begins to vibrate/rattle the Smart Trailer Monitoring System will detect the vibration and alarm the user. The system will also detect an “Off-Ball” Condition. This may be done by a system of strain gauges, pressure sensors, and/or Hall-effect sensors. Gross Trailer Tongue Weight—This feature will compute the weight felt by the hitch of the towing vehicle. It will determine if the trailer is not properly loaded. If the weight is either distributed poorly or the trailer is simply overloaded the Monitor will alert the user to redistribute the load. This is done by pressure sensor on the tongue. The sensor will tell the Monitoring System to alert the user via the display.

### Proximity Sensors:

This System allows sensors to be mounted to the exterior of any trailer for monitoring the sides and rear of the trailer to avoid vehicles and other solid objects as the driver maneuvers the trailer in traffic and other close proximity situations.

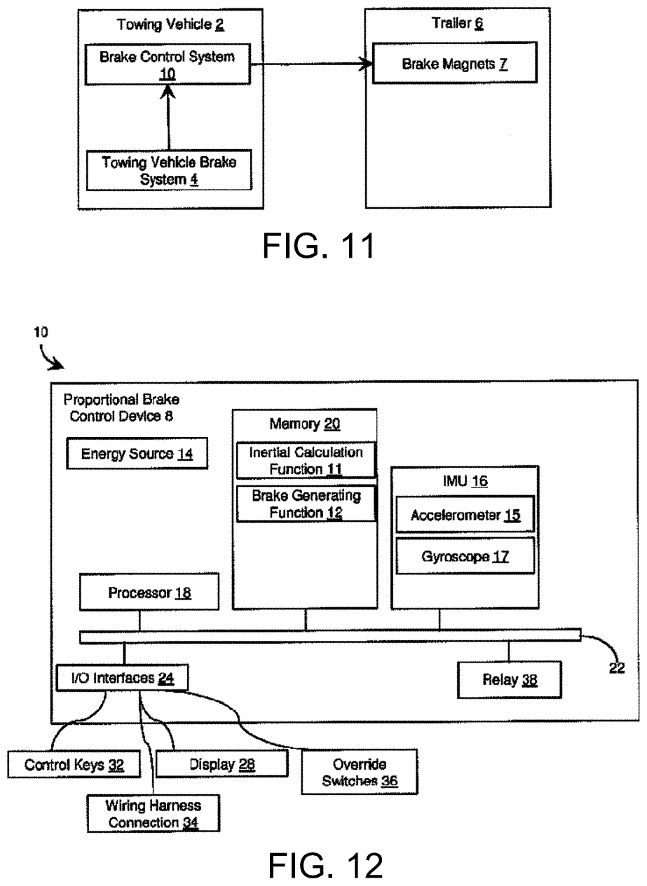

Additional description of the brake control functionality is provided below with reference to FIGS. 11-17.

With reference to FIG. 11, illustrated is a schematic block diagram of a brake control system 10 interfaced with a towing vehicle 2 and trailer 6. The brake control system 10 receives a brake switch input from the towing vehicle brake system 4. The proportional brake control system 10 then outputs a modulated brake output to the brake magnets 7 of the trailer 6.

With reference to FIG. 12, illustrated is a schematic block diagram of a proportional brake control device 8. The proportional brake control device 8 may include a brake control system 10 that may be implemented using computer technology. The brake control system 10 may be configured to execute an inertial calculation function 11 and a brake generating function 12.

In one embodiment, the inertial calculation function 11 and brake generating function 12 are embodied as one or more computer programs (e.g., one or more software applications including compilations of executable code). The computer program(s) may be stored on a machine (e.g., microcontroller unit, etc.) readable medium, such as a magnetic, optical or electronic storage device (e.g., hard disk, optical disk, flash memory, etc.).

To execute the inertial calculation function 11 and brake generating function 12, the brake control system 10 may include one or more processors 18 used to execute instructions that carry out a specified logic routine(s). In addition, the brake control system 10 may have a memory 20 for storing data, logic routine instructions, files, operating system instructions, and the like. As illustrated, the inertial calculation function 11 and brake generating function 12 may be stored by the memory 20. The memory 20 may comprise several devices, including volatile and non-volatile memory components. Accordingly, the memory 20 may include, for example, random access memory (RAM), read-only memory (ROM), flash devices and/or other memory components. The processor 18 and the components of the memory 20 may be coupled using a local interface 22. The local interface 22 may be, for example, a data bus with accompanying control bus or other subsystem.

The brake control system 10 may have various input/output (I/O) interfaces 24. The I/O interfaces 24 may be used to operatively couple the proportional brake control device 8 to a wiring harness connection 24, various control keys 32, override switches 36, and so forth. The control keys 32 may include a thumbwheel, slide button, or other suitable means. The wiring harness connection may connect the proportional brake control device 8 to the towing vehicle 2 and trailer 6. The I/O interfaces 24 may also be used to couple the device to a display 28. The display 28 may be an LCD screen(s), a status light or series of status light, or other suitable display.

The proportional brake control device 8 may include an energy source 14. The energy source 14 comprising an onboard battery, external battery, or other suitable energy source. The electronic brake control system 10 may be contained within an enclosure 40, wherein the enclosure 12 may be mounted on a towed vehicle.

The electronic brake control system 10 may further include an inertial measurement unit (IMU) 16. The IMU 16 is accessed by the inertial calculation function 11 and brake generation function 12 and outputs an acceleration vector indicating the magnitude and direction of deceleration. The IMU 16 may have five degrees of freedom, allowing for a wide range of mounting positions. The IMU 16 may comprise a combination three-axis digital accelerometer 15 and two-axis gyroscope 17. The three-axis digital accelerometer 15 may determine the acceleration vector. The gyroscope 17 may reduce noise caused by shaking and vibration and detect towing vehicle banking. The three-axis digital accelerometer 15 is susceptible to linear vibrations and the gyroscope 17 acts to filter these linear vibrations, as the gyroscope 17 only responds to changes in angular momentum. The gyroscope 17 may also be used to determine a change around the vertical axes of the accelerometer 15, e.g., due to going up and down hills.

The brake generating function 12 takes the output of the inertial calculation function 11 as an input and outputs the module brake output based on the deceleration magnitude. The IMU 16 may employ an averaging technique on the acceleration vector to minimize noise due to vibration.

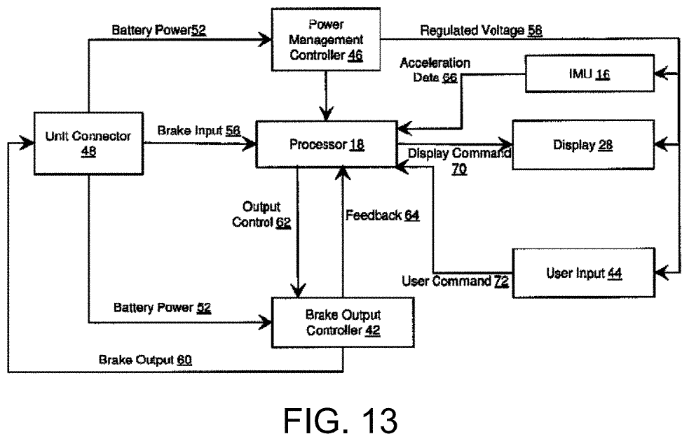

With reference to FIG. 13, illustrated is schematic block diagram of another exemplary embodiment of the brake control system 10. The brake control system 10 may include a unit connector 48. The unit connector 48 may provide battery power 52 to a power management controller 46 and brake output controller 42. The unit connector 48 may also receive brake output 60 from the brake output controller 42. The power management controller 46 may provide regulated voltage 58 to the IMU 16, display 28, and a user input 44. The user input 44 may comprise various control keys 32 and override switches 36 as described in FIG. 12. The processor 18 of the brake control system 10 may also receive power from a power management controller 46. The processor 18 may also receive brake input 56 from the unit connector 48 and feedback 64 from a brake output controller 42. In addition, the processor 18 may also receive acceleration data 66 from the IMU 16 and a user command 72 from a user input 44. The processor may also provide output control 62 to the brake output controller 42 and a display command 70 to the display 28.

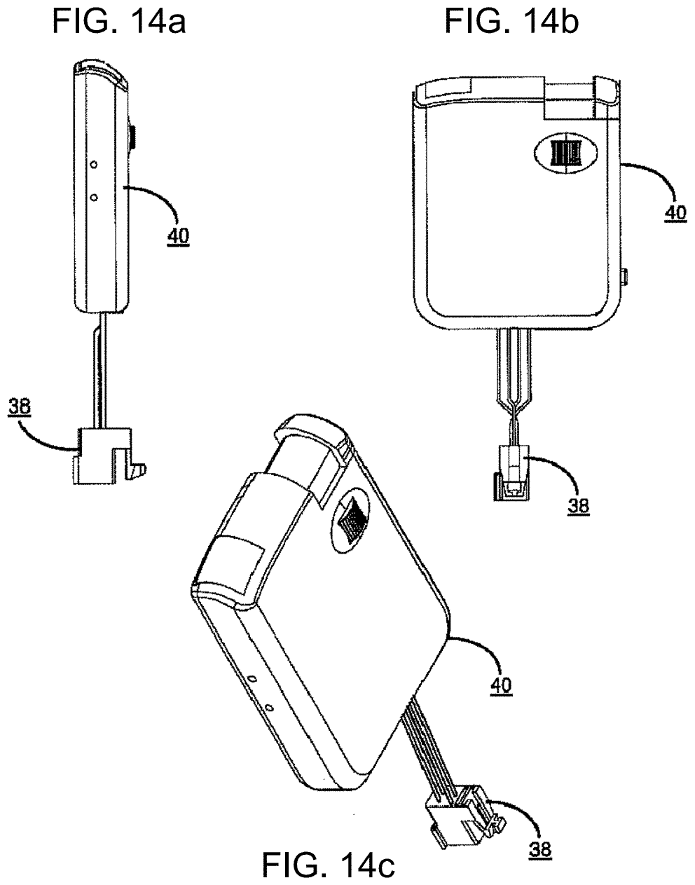

With reference to FIGS. 14A-14C, illustrated are perspective views of the enclosure 40 of the electronic brake control system 10.

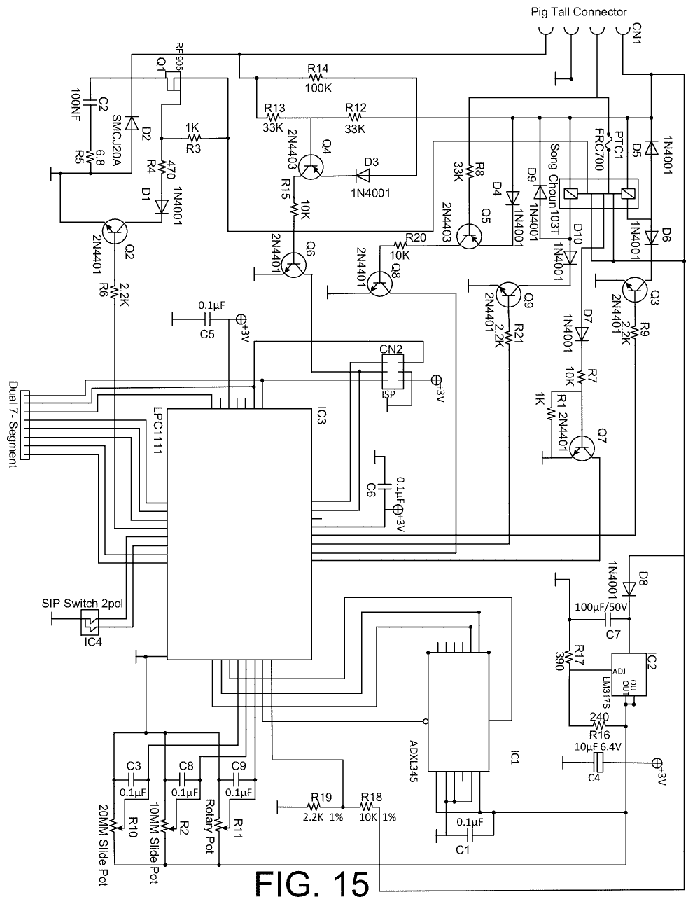

With reference to FIG. 15, illustrated is an exemplary wiring diagram of the electronic brake controller as described in FIG. 11.

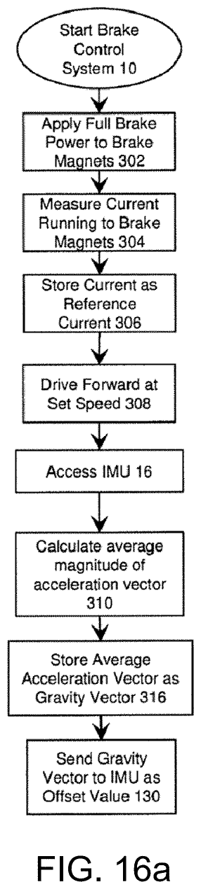

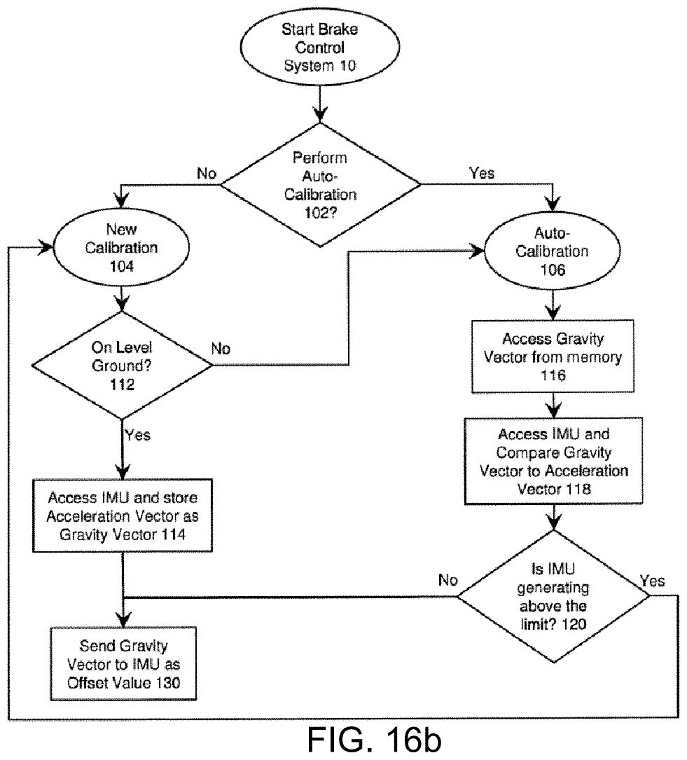

With reference to FIGS. 16a-16b, illustrated are logical operations to implement 3 o exemplary methods of generating a braking power proportional to the deceleration magnitude. Executing an embodiment of the brake control system 10, for example, may carry out the following exemplary methods. Thus, the flow diagram may be thought of as depicting steps of one or more methods carried out by the brake control system 10. Although the flow charts show specific orders of executing functional logic blocks, the order of executing the blocks may be changed relative to the order shown, as will be understood by the skilled person. Also, two or more blocks shown in succession may be executed concurrently or with partial concurrence.

With reference to FIGS. 16a-16b, the brake control system 10 may call the inertial calculation function 11. Illustrated in FIG. 16a are logical operations to implement an exemplary method of the inertial calculation function 11. The inertial calculation function 11 may apply full brake power to the brake magnets 302 and measure the current running to the brake magnets 304. This reference current 306 may be stored for use by the brake generating function 12. Next, the user may be instructed to drive forward at a set speed 308. In one embodiment, the set speed may be 25 mph. In another embodiment, the set speed may be 10 mph. While driving at a set speed, the inertial calculation function 11 may access the IMU 16 and calculate the average magnitude of the acceleration vector 310. The average magnitude of the acceleration vector may be stored as the gravity vector 316. The gravity vector may also be sent to the IMU as the offset value 130.

With reference to FIG. 16b, illustrated are logical operations to implement another exemplary method of the inertial calculation function 11. The inertial calculation function 11 may query whether to perform auto-calibration or a new calibration 102. A user may select the type of calibration to perform, or the inertial calculation function 11 may choose a type of calibration by default. For example, by default the inertial calculation function 11 may perform auto-calibration 106 each time a wiring harness is connected to the wiring harness connection 34 of the proportional brake control device 8. Alternatively, the inertial calculation function 11 may perform new calibration 104 if the output of the accelerometer 15 is beyond a predetermined threshold. Alternatively, the inertial calculation function 11 may perform new calibration 104 only if the output of the gyroscope 17 has changed.

If auto-calibration 106 is not selected, a new calibration 104 is performed. When performing a new calibration 104, the inertial calculation function 11 may first determine if the vehicle is on level ground 112. The inertial calculation function 11 may determine if the vehicle is on level ground 112 by querying a user or accessing the accelerometer 15 to determine if the acceleration vector is within a range of values known to signify level ground. Additionally, the inertial calculation function 11 may query the gyroscope 17 to determine if the proportional brake control device 8 is on level ground.

If not on level ground, the inertial calculation function 11 may perform auto-calibration 106 instead. If on level ground, the brake generating function may access the IMU 16 and store the acceleration vector as a gravity vector 114. Next, the inertial calculation function 11 may send the gravity vector to the IMU 16 to be used as an offset value 130. The accelerometer 15 uses the offset to adjust its output by subtracting the gravity vector from the acceleration vector. The result is that at level ground after calibration, the acceleration vector output of the IMU 16 is zero, removing the effects of gravity from the IMU 16. The gravity vector may also be saved into memory 20 as reference for auto-calibration.

If auto-calibration 106 is selected, a gravity vector is accessed from the memory 116. The gravity vector may next be compared to the acceleration vector 118. If the IMU 16 is generating above the gravity vector, then the system may go into new-calibration mode 104. Generating above the gravity vector occurs when the gravity vector is less than or equal to a generating constant multiplied by the acceleration vector. The generating constant may be within in the range of 1 to 1.15. The generating constant may also be equal to one. The gravity vector is sent to the IMU 16 as the offset value 130 if the IMU 16 is not generating above the gravity vector.

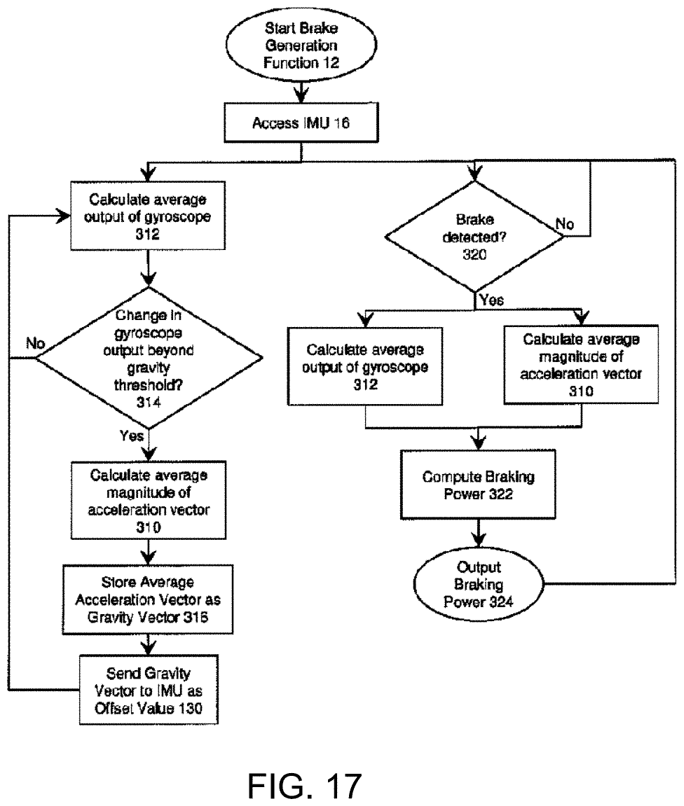

With reference to FIG. 17, the brake control system 10 may call the brake generating function 12. The brake generating function 12 may access the IMU 16 and calculate the average output of the gyroscope 312. Next, the brake generating function 12 may monitor the output of the gyroscope for a change beyond a gravity threshold 314. The gravity threshold may be within a range of values from 0.75 to 1.25.

If a change in gyroscope output beyond the gravity threshold is detected, the average magnitude of the acceleration vector is calculated 310. The average acceleration vector is then stored as the gravity vector 316 and sent to the IMU as the offset value 130.

While monitoring for a change in gyroscope output 312, the brake generation function 12 may monitor for braking 320. Braking may be detected 320 by the brake switch input from the towing vehicle brake system 4. Brake activation 210 may also be detected by a sudden change in the acceleration vector or gyroscope output. When braking is detected, the brake generating function 12 may calculate the average output of the gyroscope 312 and the average magnitude of the acceleration vector 310. Next, the output of the gyroscope and the average magnitude of the acceleration vector may be used to compute the braking power 322. The current reference may also be used when calculating the braking power 322. The brake generation function 12 may then output the computed braking power 324.

The proportional brake control device 8 may have two override switches 36 that enable/change the function of the brake control system 10. One switch may determine the maximum output of the duty cycle. The switch may either use the gain setting or a maximum value, e.g., 9.9, as the maximum output. The other switch can cause the energy source 14 to supply a set voltage, e.g., 12V, when the switch is activated.

The proportional brake control device 8 may also have a relay 38 that supplies power to the proportional brake control device 8. This relay 38 is only activated when a user engages an override switch 36 or steps on the brake. This will prevent system damage during installation cause by miswiring.

Error codes may be displayed on the display 28 of the proportional brake control device 8. For example, a trailer disconnect may be signaled by flashing a “dc” on the display 28 for 30 seconds, then reverting to displaying a single dot every time an override switch is activated or brake input is applied. Additionally, an output overload may be signaled by flashing an “OL” on the display 28 and polling the output by pulsing it to determine if the overload still exist. Additionally, a stop lamp overload may be signaled by flashing “El” on the display 28 while still applying manual brake override. Additionally, a low battery may be signaled by displaying “Lb” until battery voltage is above a set minimum value.

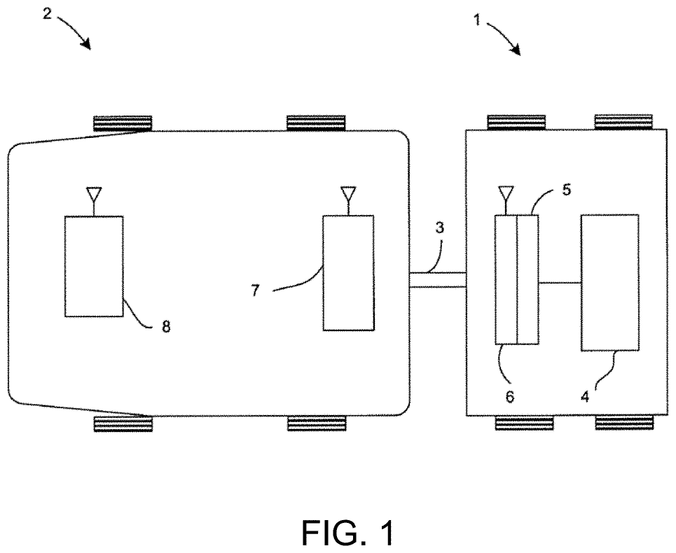

Additional description of the trailer light monitoring functionality is provided below with reference to FIGS. 1-10.

Aspects of the disclosed technology relate to a wireless trailer monitoring and control system that is configured to detect electrical fault conditions occurring with a trailer and alert the driver of a towing vehicle to such electrical fault conditions. The system makes use of monitoring and/or detection circuitry and a wireless interface to enable wireless transmission of such fault conditions to a driver of a towing vehicle without any hard wiring existing between the towing vehicle and the trailer. A further aspect of the disclosed technology relates to a wireless brake and/or lighting control system in which the trailer brakes and/or lights may be controlled by way of a wireless interface between the trailer and the towing vehicle.

FIG. 1 illustrates a trailer 1 being towed by a vehicle 2 by way of a suitable hitch assembly 3. The trailer 1 includes a trailer harness (shown schematically as 4) made up of various electrical systems within the trailer, e.g., an electric brake system and various lighting systems. The harness 4 is operatively coupled to one or more monitoring circuits (also referred to as detection circuits or fault detection circuits) 5. The monitoring circuitry is operatively coupled to or otherwise integrated with a first transceiver (also referred to as a trailer transceiver) 6. The trailer transceiver 6 is configured to wirelessly communicate with an associated first towing vehicle transceiver 7, which is operatively coupled to a portion of an associated towing vehicle, for example, to a portion of a harness of the towing vehicle. The first towing vehicle transceiver 7 is configured to wirelessly communicate with a driver alert or status module 8, whereby the driver alert or status module 8 is integrated with or operatively coupled to a transceiver. As is discussed more fully below, the wireless system may be employed for a variety of trailer monitoring and/or controlling functions.

It will be appreciated from the following discussion that the wireless communication platform described herein may be employed for or in connection with one or more of the following applications: wireless monitoring of lighting fault conditions occurring with the trailer, e.g., malfunctioning tail lights, brake lights or turn signal lights, a wireless system for monitoring trailer brake malfunction, a wireless system for controlling lighting and/or braking of a trailer, a wireless system for monitoring and/or controlling stability or yaw associated with the trailer, a wireless system for monitoring the status of a coupler and a connection point between a towing vehicle and a trailer, a wireless system for monitoring cargo-related activity, e.g., tongue weight or status of cargo disposed within the trailer, and the like.

In one embodiment, a wireless trailer harness monitoring system is provided. The monitoring system may be configured to monitor the functioning of all trailer lights, e.g., tail lights, brake lights, turn signal lights or the like. The monitoring system may be configured such that a trailer transceiver interfaces with the existing four-wire trailer harness system. The monitoring system will alert the driver of the towing vehicle if there is a problem with the trailer lighting converter or with the trailer lighting itself.

To determine if the harness system is in working condition, the monitoring system may make use of high-side current sensors in line with a suitable resistor, e.g., a 0.01 ohms resistor, as the shunt, to determine if a proper amount of current is passing through. Each time a proper current passes through, it will flag the section of the harness as good.

To determine if the trailer bulbs are damaged, a pull-up resistor may be employed on the signal wires. If there is a damaged or otherwise defective bulb, that line will not be able to pull down the voltage on the pull-up resistors.

Any suitable transmitter, receiver or transceiver may be employed for the trailer transceiver and the towing vehicle transceiver. One suitable type of transmitter/receiver is the type often used in connection with automotive wireless keyless entry. For example, a TXC2 transmitter and/or a RXA3 receiver may be employed. Both are available from Spirit-On Enterprise Co., Ltd. Using these types of transmitters/receivers, the carrier frequency may be centered at 433.92 MHz using Amplitude Shift Keying (ASK) or sometimes called On-Off Keying (OOK) as the modulation.

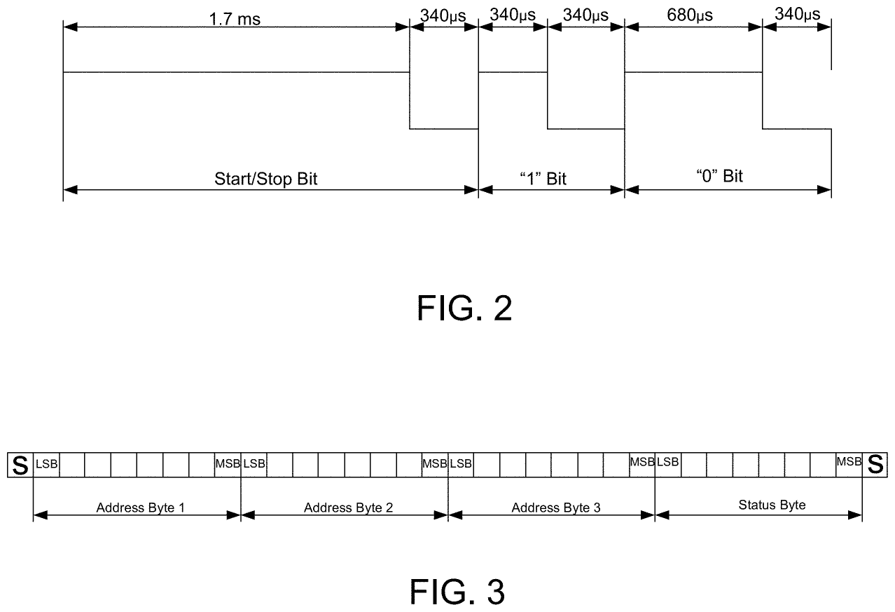

Wireless communication between the trailer transceiver and the towing vehicle transceiver may be accomplished via variable pulse width modulation (PWM) encoding to encode the bits to be sent over. FIG. 2 provides an exemplary bits profile that may be employed in connection with the disclosed technology.

In one embodiment, there will be a total of four bytes to be sent, excluding start/stop bits. Three bytes may be used for the unit's address. Each pair has a unique address to prevent cross over talk when two pairs are in close proximity with each other. The last byte is the status byte.

TABLE 1
Status Byte

| Bit | Function |
|---|---|
| 0 | Left Bulb Good |
| 1 | Left Bulb Bad |
| 2 | Right Bulb Good |
| 3 | Right Bulb Bad |
| 4 | Taillight Bulb Good |
| 5 | Taillight Bulb Bad |
| 6 | Transmitter Online |
| 7 | Low Battery Indicator |

Transmission of data may be accomplished by sending the least significant bit first. FIG. 3 provides an exemplary data stream that may be employed in connection with the disclosed technology.

The trailer transmitter/transceiver (and associated fault detection circuitry) will check the left, right and tail signal in real-time, but may only transmit if there is a change in the harness. In one embodiment, if there is no change for five seconds, for example, the transmitter/transceiver will transmit just to let the receiver know that it's still online. If the towing vehicle receiver/transceiver does not receive any data from the transmitter for twelve seconds, for example, then the transmitter will display an error to notify the driver.

In accordance with another embodiment, the wireless monitoring system may be configured as a wireless brake monitoring system used in connection with a trailer electric brake controller. A trailer brake monitoring circuit may be connected in series with a standard trailer electric brake controller, thereby providing an audible and/or a visual alarm if the trailer electric brakes become disconnected. As is discussed more fully below, the wireless trailer brake monitoring system may operate in conjunction with a pulse width modulation (PWM) output from a standard trailer brake controller. In one embodiment, a sensor in series with the PWM output device, a PNP power transistor, provides a voltage level to a comparator circuit which controls a RED LED visual indicator. A separate comparator circuit monitors the output directly and with proper output connections, illuminates a GREEN LED.

In the event of trailer brake discontinuity, an audible alarm may be sounded for a predetermined amount of time, e.g., for 3-5 seconds, the GREEN LED may be inhibited, and the RED LED may blink for 3-5 seconds in sync with the audible alarm and then be subsequently illuminated to maximum intensity until the discontinuity is corrected.

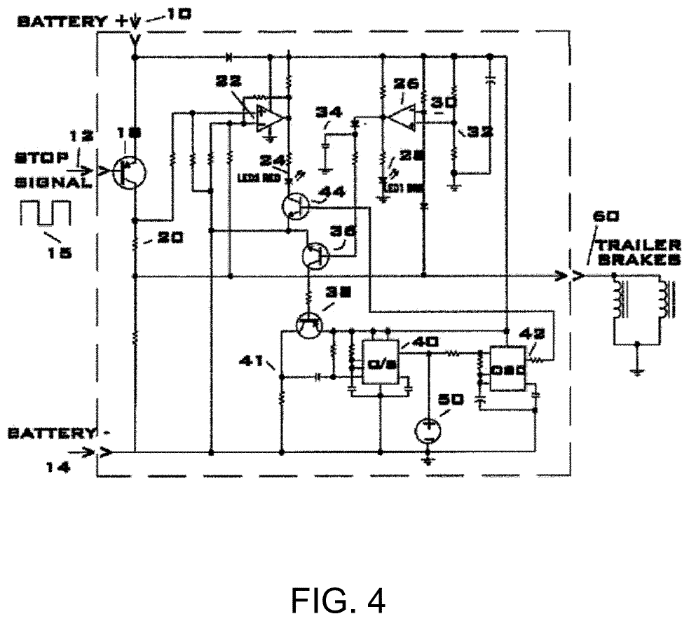

Turning now to FIG. 4, an electrical schematic of a trailer brake monitoring circuit for use in connection with a trailer brake monitoring device is provided. The monitoring circuit is operative to wirelessly communicate trailer brake disconnection information to the towing vehicle in the form of visual and/or audible alarms in the event of disconnection or malfunction of the trailer brakes.

Four (4) connections are made, Battery+ (10), Battery− (14), Stop signal from the brake controller (12), and an output to the trailer brakes (60).

At quiescence, i.e., no stop signal is present, there is no current through sensor (20) and no voltage is applied to the non-inverting input of comparator (22). Thus the output of comparator (22) is LO, inhibiting RED LED (24). The non-inverting input (32) of comparator (26) is referenced at a level above ground. There is no voltage to the trailer brakes (60) which is monitored by the inverting input (30) of comparator (26). Thus the output of comparator (26) is HI, illuminating GREEN LED (28) and charging integrator capacitor (34) which enables NPN transistor (36) which enables PNP transistor (38), holding the trigger input (41) HI to One-shot (40). This precludes One-shot (40) from operating which maintains a LO output to the audio alarm (50) and Oscillator (42) trigger. In summary, in quiescence, the GREEN LED is illuminated, the RED LED and the audio alarm are inhibited.

When a PWM (15) STOP signal (12) is present, a positive voltage is developed across sensor (20), switching the output of comparator (22) HI and illuminating RED LED (24) in proportion to the PWM signal. The GREEN LED remains illuminated due to the AC component of the output to the trailer brakes, which inhibits the audio alarm.

When the trailer brake output (60) sees a discontinuity, the resulting high impedance results in a DC level at the inverting input of comparator (26). Thus comparator (26) output is switched LO, turning “off” GREEN LED (28), inhibiting NPN transistor (36) and thus PNP transistor (38) which triggers One-shot (40) for 3-5 seconds. The audio alarm (50) is activated and Oscillator (42) is enabled which blinks RED LED (24) for 3-5 seconds. When One-shot (40) times out, Oscillator (42) output remains HI, enabling the RED LED to maximum illumination until the discontinuity is corrected.

Trailer electric brake controllers provide visual indication of power levels applied to the trailer electric brakes. This level is determined by the pulse width and is set by the operator with manual control of the brake controller to obtain optimum braking of the trailer. This visual indicator does not alert the driver if the trailer electric brakes become disconnected. The trailer brake monitor provides both a visual and audible alarm.

The trailer brake monitor may be connected in series with a standard trailer electric brake controller, thereby providing both an audible and visual alarm if the trailer electric brakes become disconnected.

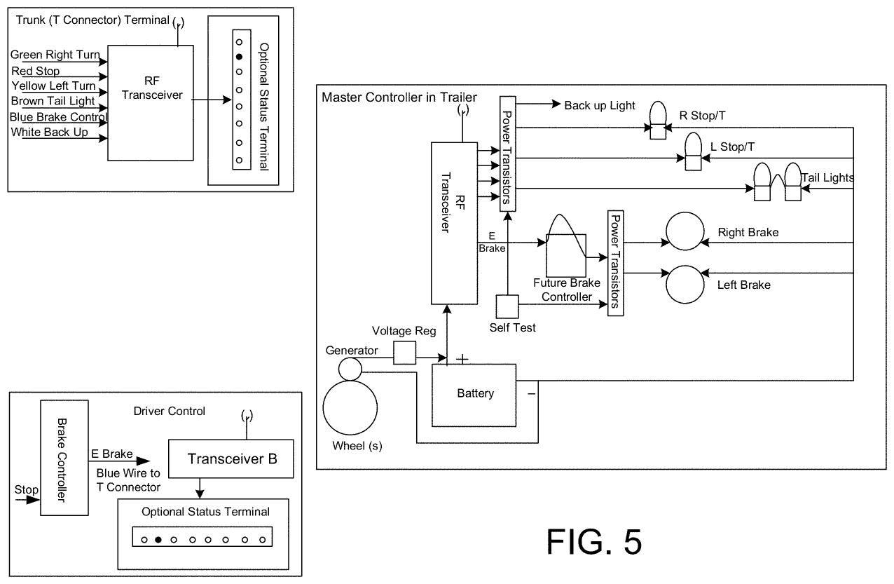

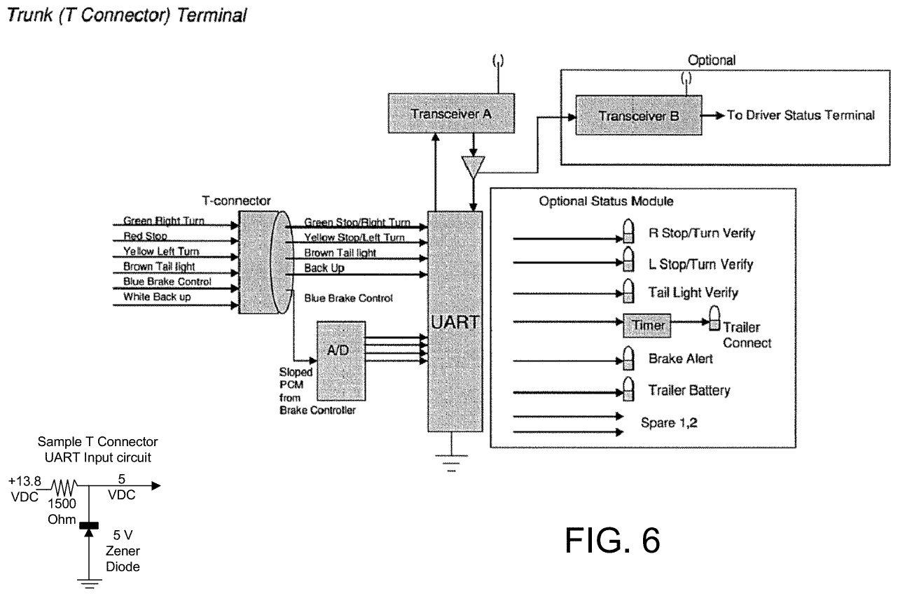

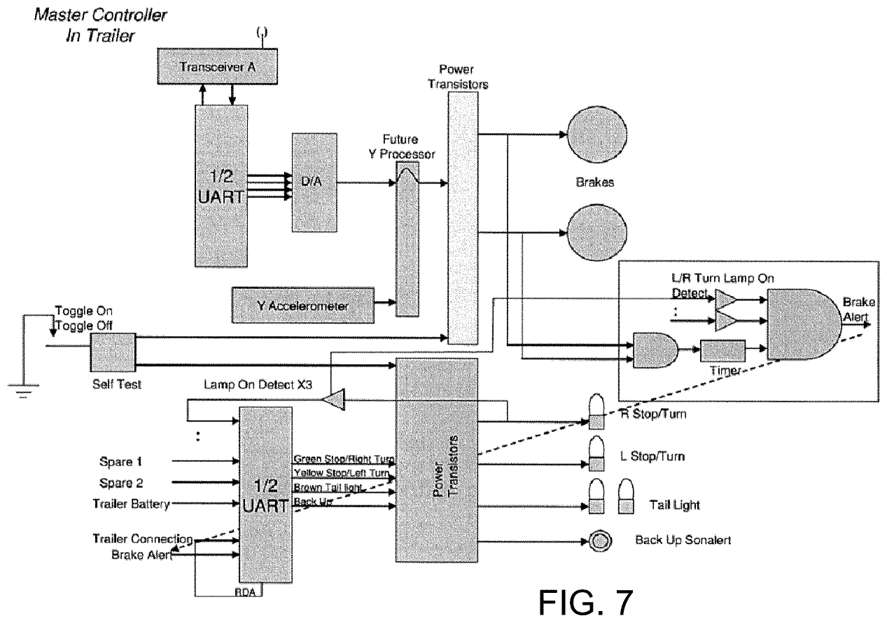

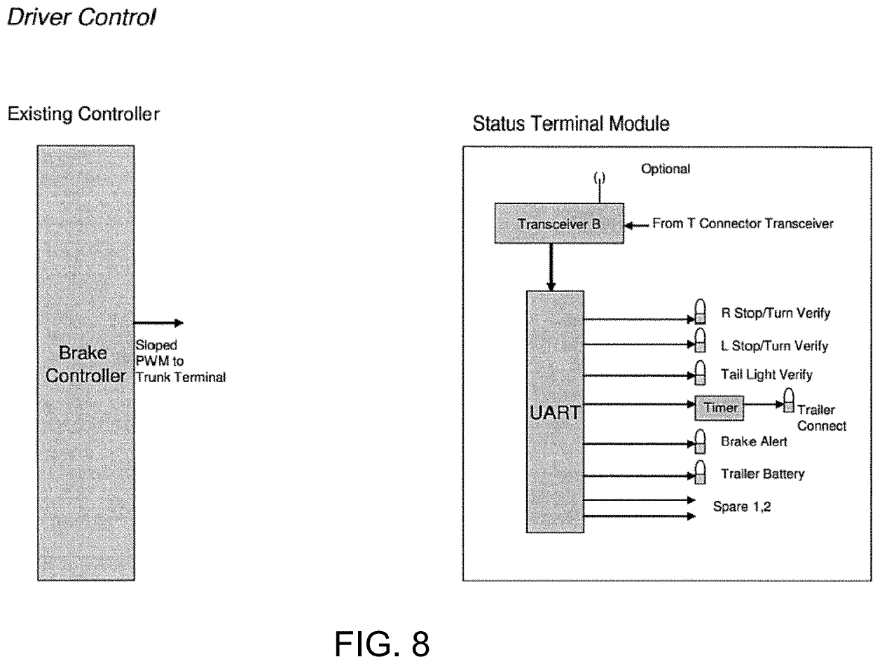

Turning now to FIGS. 5-8, an exemplary wireless trailer monitoring and control system is provided. The wireless trailer monitoring and control system includes a trailer controller portion in which a control and/or monitoring circuit is operatively coupled to, in a preferred embodiment, an existing trailer control circuit by plugging the trailer detection and transceiver circuit into the trailer control harness. A towing vehicle control terminal includes a radio frequency transceiver operatively coupled to a portion of the vehicle harness, for example, using a standard connection to a T Connector in the trunk of the towing vehicle. A driver control and/or alert module includes a wireless transceiver that is configured to communicate with the trunk transceiver and, optionally, includes one or more status indicators to communicate status information to a driver of the towing vehicle. FIG. 6 shows a more detailed schematic of an exemplary trunk (T Connector) terminal and FIG. 7 shows a more detailed view of an exemplary master controller in the trailer. FIG. 8 provides a more detailed view of an exemplary driver control and/or alert module, including the status terminal module.

Upon establishment of the herein described wireless platform for trailer monitoring and/or control, it will be appreciated that a variety of other applications may be accomplished using the wireless system. For example, as is described above, the wireless system may be employed for controlling lighting and/or braking of the trailer.

In addition, it will be appreciated that the wireless system (and the components within the system) may be modified to accomplish other control and/or monitoring functions without departing from the scope of the present invention. For example, by providing appropriate sensors and/or control modules, the trailer's side-to-side motion or yaw may be monitored and controlled to provide a more stable operation of the trailer. In another example, where the connection point between the towing vehicle and the trailer may include a coupling mechanism having electronic components, the status of the coupler may also be monitored by way of the wireless system. For example, a suitably-enabled electronic coupler may provide data as to the force with which the coupler is held onto the hitch. In the case where the force drops below a predetermined threshold, an alert or fault signal may be relayed wirelessly to the driver by way of the status or alert module.

In yet another application, the wireless system may be employed in the monitoring of cargo-related activity. For example, with the use of appropriate force sensors, the tongue weight of the trailer may be monitored and wirelessly communicated to the driver, e.g., by displaying the information on the driver status/alert module. If the tongue weight is found to exceed a predetermined threshold, an alarm may be presented to the driver, at which point, the driver can take appropriate action to remedy the situation.

Further, in a system in which stability of the cargo may be monitored, such stability information may be wirelessly communicated to the driver by way of the wireless monitoring and/or control system described herein. For example, in the case of a motorcycle being towed within the trailer, it may be possible with use of appropriate force sensors to monitor the pressure points on harness members securing the motorcycle within the trailer. If it is determined that one or more of the pressure points falls outside of a predetermined tolerance range, an alarm signal may be wirelessly communicated to the driver alert module. In yet another cargo-related embodiment, the trailer and the towing vehicle may be configured such that a “quick-look camera” and light source is employed. In this exemplary embodiment, the driver may be able to indicate a desire for a “quick look” at the cargo. Upon actuation of an appropriate control function, a light source may illuminate the cargo and an appropriate camera may capture an image of the cargo, whereby the image of the cargo is wirelessly transmitted to the driver alert module for display on the module. Other applications may become apparent to one of ordinary skill in the art upon a reading and understanding of this detailed description.

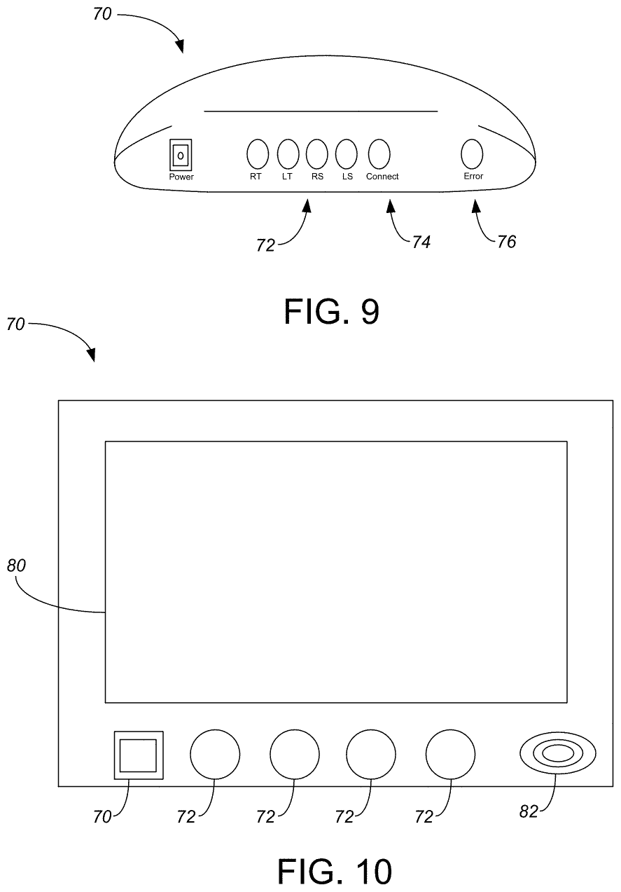

Turning now to FIGS. 9 and 10, it will be appreciated that the driver alert module may take on a variety of forms depending on the particular functions being carried out by the wireless monitoring and/or control system. For example, FIG. 9 shows an exemplary driver alert module 70 having a plurality of status indicator lights, e.g., LEDs, with each status light representing the status of a different trailer electrical component. For example, in the case of monitoring the lighting of the trailer, the driver alert module may include one status indicator LED 72 for each light within the trailer, for example, a right turn light, a left turn light, a right brake light, a left brake light, and the like. Also, the driver alert module may include a status indicator light 74 that indicates and/or verifies that the trailer is still connected to the towing vehicle. In addition, the driver alert module may include an error light 76, which, when in a red or fault state, would be indicative of an error with the wireless communication system. Of course, it will be appreciated that the invention is not limited to any particular configuration and/or number of status indicator lights on the driver alert module.

Further to this point, FIG. 10 provides an alternative exemplary embodiment of a driver alert or status module 70. In this case, the driver alert module includes a display screen 80 on which a variety of different information can be displayed, including, but not limited to, information related to tongue weight, cargo stability, brake fault status, trailer lighting status, and the like. The exemplary driver alert module with display may also include a plurality of status indicator lights 72 as well as a general error light and a speaker 82 through which an alert may be sounded, for example, if it is detected that the trailer brakes are disconnected or otherwise in a fault condition.

It will be appreciated that the provision of a wireless system for trailer monitoring and/or control may provide numerous advantages, such as simplified communication between a trailer and a towing vehicle. In addition, the provision of a wireless system for trailer control and/or monitoring facilitates enhanced control of trailer operations.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A vehicle trailer management system comprising:
at least one trailer system component;
a trailer system controller operatively coupled to the at least one trailer system component;
a trailer system sensor operatively coupled to the at least one the at least one trailer system component;
a control area network bus operatively coupled to the at least one trailer system component and configured to connect the at least one trailer system component with the trailer system controller and the trailer system sensor;
a transceiver operatively coupled to the control area network bus and operatively coupled to a user interface, the transceiver transmitting and receiving signals between the control area network bus and the user interface.

2. The vehicle trailer management system of claim 1, wherein the trailer system sensors are configured to monitor a trailer lighting system, tire pressure, a trailer brake system, on board cameras, trailer mileage, hub temperature, proximity sensors, and/or sway controls

3. A wireless vehicle trailer monitoring system comprising:
a monitoring circuit operatively coupled to a trailer controller, the monitoring circuit configured to detect a fault condition with an associated trailer;
a trailer wireless transceiver operatively coupled to the monitoring circuit; and
a towing vehicle wireless transceiver operatively coupled to an associated towing vehicle, wherein the trailer wireless transceiver is configured to communication wirelessly with the towing vehicle wireless transceiver.

4. The vehicle trailer monitoring system according to claim 3, wherein the monitoring circuit is configured to detect trailer brake malfunction or disconnection.

5. The vehicle trailer monitoring system according to claim 3, wherein the monitoring circuit is configured to detect trailer light malfunction or disconnection.

6. The vehicle trailer monitoring system according to claim 3, wherein the monitoring circuit is configured to detect a fault condition related to tongue weight

7. The vehicle trailer monitoring system according to claim 3, wherein the monitoring circuit is configured to detect a fault condition related to status of cargo disposed within the trailer.

8. The vehicle trailer monitoring system according to claim 3,wherein the monitoring circuit is configured to detect a fault condition related to of a status of a coupler coupling the trailer to the towing vehicle.

9. The vehicle trailer monitoring system according to claim 3, wherein the monitoring circuit is configured to detect a fault condition related to trailer yaw.

10. A proportional brake control device comprising a brake control system, the device comprising:
an inertial measurement unit, comprising an accelerometer and a gyroscope, wherein the accelerometer outputs an acceleration vector and receives an offset value, wherein the acceleration vector comprises acceleration measurements along at least three axes and the offset value is subtracted from the acceleration vector before output from the inertial measurement unit;
a memory;
a relay, wherein the relay receives a brake input; and
a processor programmed to execute a program comprising the brake control system, wherein the brake control system comprises an inertial calculation function and a brake generating function;
wherein the inertial calculation function is configured to:
apply full brake power to a brake magnet;
measure and store the current running to the brake magnets as the current reference;
prompt a user to drive forward at a set speed;
access the inertial measurement unit;
calculate an average magnitude of the acceleration vector;
store the average magnitude of the acceleration vector as a gravity vector;
store the gravity vector in the inertial measurement unit as the offset value;
wherein the brake generating function is configured to:
access the inertial measurement unit;
calculate the average output of the gyroscope;
monitor for a change in the average output of the gyroscope;
if a change is detected:
calculate the average magnitude of the acceleration vector;
store the average acceleration vector as the gravity vector; and
store the gravity vector in the inertial measurement unit as the offset value;
if braking is detected:
calculate the average magnitude of the acceleration vector;
calculate average output of gyroscope;
compute braking power using the average magnitude of the acceleration vector and the average output of the gyroscope;
output braking power.

11. The brake control system of claim 10, wherein the set speed is 25 MPH.

12. The brake control system of claim 10, wherein the reference current is used when computing braking power.

13. The brake control system of claim 10, wherein the set speed is 10 MPH.
